(19) United States
(12) Patent Application Publication
(10) Pub. No.: US 2015/0150666 A1
(43) Pub. Date: Jun. 4, 2015

(54) Mammal Semen Collection and Filtration Device

(71) Applicant: Richard Muller, Boone, IA (US)

(72) Inventor: Richard Muller, Boone, IA (US)

(21) Appl. No.: 14/096,102

(22) Filed: Dec. 4, 2013

(51) Int. Cl. A61D 19/02

(52) U.S. Cl. CPC A61D 19/021

(57) ABSTRACT

A ridged cylinder is fused to a sheet of filter material that extends to form a pouch. When the cylinder is placed into the opening of a vessel of a matched diameter, it creates a barrier via the filter material, through which all materials must pass to reside in the vessel. The mammal's penis is directed to ejaculate into the cylinder, and the ejaculate plug is retained by the filter material, while the semen passes through the filter and into the vessel. When the collection is complete, the cylinder and attached filter material are removed from the vessel and disposed of.

### CROSS REFERENCE TO RELATED APPLICATIONS

This application claims priority under 35 U.S.C. #119(e) from a provisional patent Ser. No. 61/733,229 application filed Dec. 4, 2012, which is incorporated herein by reference for all purposes.

### BACKGROUND OF THE INVENTION

1. Field of the Invention

The present invention is a method and apparatus that provides an inexpensive, quick, and portable means to separate the undesired components from a sperm sample. The invention is related to equipment in support of mammal artificial insemination in general, and to an apparatus for collecting and filtering mammal semen in particular.

2. Discussion of the Related Art

Artificial Insemination (AI) is a common technique employed for the purposed of procreation of a variety of mammals. In particular, AI is used to deliver biological liquids, i.e. semen, to the reproductive tract of a female mammal. Typically, these biological liquids are collected into a vessel after passing through some sort of filtration device.

As is known to those skilled in the art, AI technology has made it possible to inseminate larger numbers of females than traditional mating. Further, AI technology has made it possible to collect semen from a male mammal without contact with the female. Accordingly, this allows for the insemination of each female with a controlled quantity of semen in an isolated environment such that the chances of insemination and number of offspring per male are greatly increased.

While there are methods available for the collection of medical specimens, some have characteristics in their filtration methods and construction that are not favorable to the collection of semen and sperm cells.

The methods to collect and filter mammal semen vary based on species. For example, boar semen has been collected and filtered via devices that include a device in which the filter is attached to the upper portions of a bag after which the upper portion, filter, and unfiltered ejaculate are disposed of, leaving the lower portion of the bag and the filtered semen. Other methods include using a rubber band to secure the filter to the outside of a collection mug. These methods do not provide a ridged form to keep the unfiltered ejaculate contained, allowing the possibility of spilling the unfiltered ejaculate into the filtered semen and contaminating it. The unfiltered ejaculate could also be spilled onto other equipment, the collection technician, or some other unwanted place.

Other methods to collect and filter semen are utilized most often for filtering human semen, and have specifically designed materials, such as nylon mesh of a specific density, and methods for ensuring that only motile sperm cells are recovered; not allowing for seminal plasma or other portions of the collection that may be of benefit to the further use or preservation of the sperm cells to remain, and as such require the use of a receiving medium.

The below-referenced U.S. patents disclose embodiments that were at least in-part satisfactory for the purposes for which they were invented. The disclosures of all below-referenced prior United States, patents, in their entireties are hereby expressly incorporated by reference into the present application for purposes including, but not limited to, indicating the background of the present invention and illustrating the state of the art.

U.S. Pat. No. 4,439,319 discloses a receptacle for the collection of medical specimens formed of inner and outer open-topped containers, with the inner container divided into upper and lower compartments. The upper and lower compartments are divided by a foraminous partition that is mounted to be easily removable upwardly from the inner container and receive the solid, semi-solid, etc portions of the sample and thus needs to be of significant strength to support itself and the other contents when removed.

U.S. Pat. No. 5,961,503 discloses a boar semen collection bag comprising of a pair of flexible flat plastic segments sealed along the edges to present an upwardly opening bag. A pouch is positioned within the collection bag. When the bag is disposed within a collection mug, the upper portions thereof extend as a shroud around the exterior of the mug. Once the semen is received within the mug, the semen passes through a filter material and into the collection bag. The upper portion of the bag, along with the filter and unfiltered ejaculate, is removed from the lower portion that contains the semen and is disposed of.

U.S. Pat. No. 6,129,214 and it's continuation U.S. Pat. No. 6,357,596 disclose a sperm strainer apparatus for filtering motile sperm from the sperm sample using a membrane assembly disposed in a container, with a sperm sample placed on one side of the membrane and the motile sperm migrate through the membrane into a receiving medium where they can be extracted. The membrane in use is made of nylon and is manufactured to create a barrier that only motile sperm cells can move through. The assistance of gravity is not required for the motile sperm to pass through.

In summary, problems heretofore exhibited in the art include: methods that are not favorable for the collection of semen, use of flexible forms that can potentially allow filtered semen to be contaminated by unfiltered ejaculate when the collection technician attempts to remove the upper portion from the lower portion, and the exclusionary action of separating the motile sperm cell from the beneficial parts of the collection.

What is needed is a method and apparatus that can passively isolate the semen sample from the undesired components. The device should be inexpensive and easy-to-use. The method screens out the undesired components leaving high quality semen for processing and insemination. The device should have a ridged form and filter made to restrict only the undesired components of the collection and other contaminates from passing through.

### SUMMARY OF THE INVENTION

By way of summary, the present invention is directed to a semen collection and filtration device. An effect of the present invention is to contain the unfiltered ejaculate portion with in the ridged form when removed from the semen vessel and therefore prevent contamination of the filtered semen. A primary object of the invention is to provide a ridged form fused to a filter such that when the invention is removed from its matching vessel, there is a decreased probability of contamination of the filtered semen. Another object of the invention is to provide a collection and filtration device that is reliable, thereby decreasing down time and operating costs. Another object of the invention is to provide a collection and filtration device that has one or more characteristics discussed above but which is relatively simple to manufacture and assemble using a minimum of equipment. Another object of the invention is to provide a collection and filtration device that can be used with a variety of vessels to hold the filtered semen.

In accordance with a first aspect of the invention, these objects are achieved by providing a cylinder having a first open end to receive the semen or biological liquid. The cylinder includes a second end opposite the first end having a filtration medium fused to the cylinder.

These and other aspects and objects of the present invention will be better appreciated and understood when considered in conjunction with the following description and the accompanying drawings It should be understood, however, that the following description, while indicating a preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a cross-sectional view of the semen collection and filtration device

FIG. 2 is a top plan view of the semen collection and filtration device of FIG. 1

FIG. 3 is a cross-sectional view of the semen collection and filtration device of FIG. 1-2 installed to a vessel and receiving the components of an ejaculation.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word constructed, attached or terms similar thereto are often used. They are not limited in direct connection but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

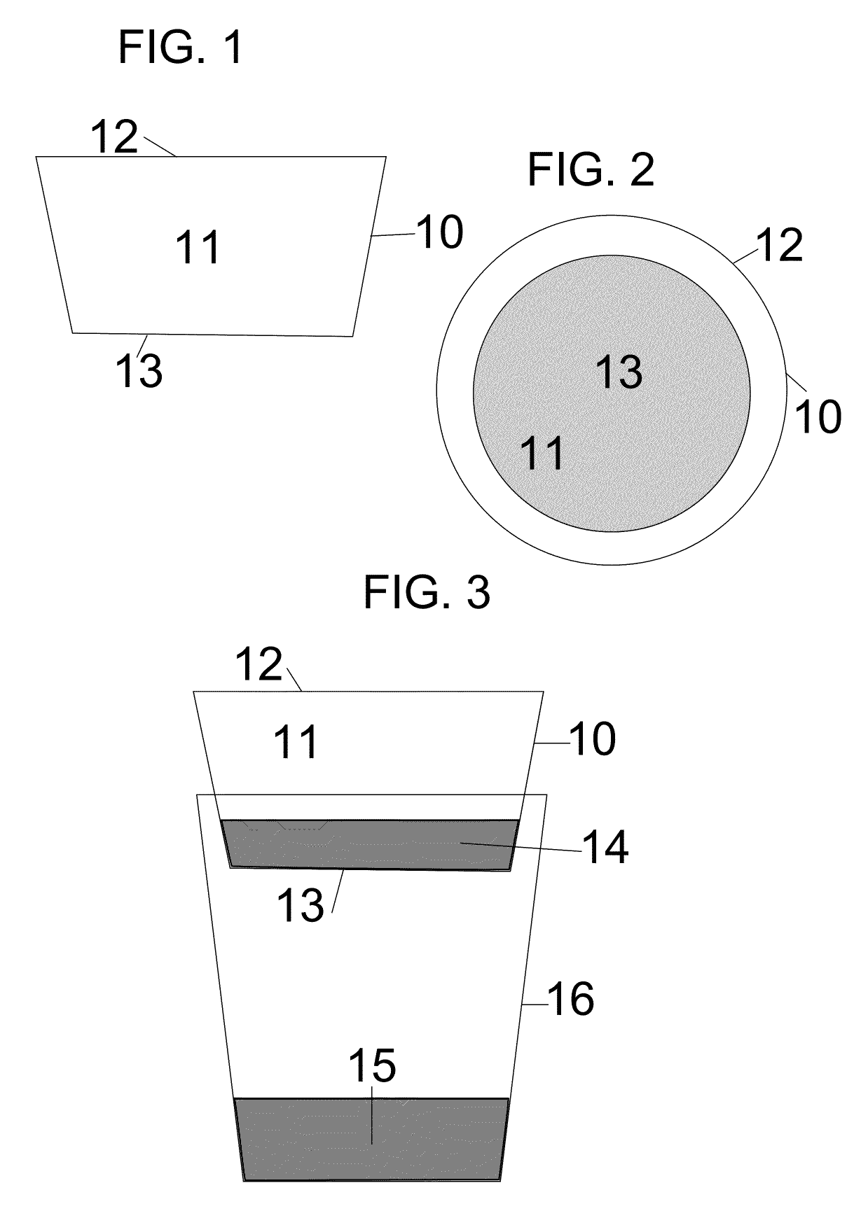

Referring now to the drawings, and initially to FIGS. 1-3, a cylinder for collection and filtration of mammal semen comprises cylinder 10 having a hollow body 11 defining a cavity and having a first end 12 for receiving semen and other biological liquids of an ejaculate 14 and a filter 13 fused to the opposite of the first end 12. After the ejaculate is introduced into the cylinder 10 via the first end 12, the semen 15 passes through the filter 13, and falls into a vessel 16. The remaining ejaculate 14 is contained in the cylinder 10 by the filter 13 and together all three are disposed of. The collected semen 15 in the vessel 16 is then passed on to a semen processing area.

The collection cylinder 10 thus provides for rapid installation of a collection and filtration device onto the vessel 16, eliminating the need to separately attach a filter element. In addition, because no manual manipulation of the filter element is required, the hygienic condition of the surfaces of the collection vessel which come into contact with the semen is preserved. In addition, the filter and waste ejaculate material may be removed from the vessel without contacting the collector's hands.

The cylinder 10 thus provides several advantages. It minimizes contamination of the collected semen and does not require the filter to be handled in setup. The filter 13 provides for high flow rate of semen.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

Moreover, the individual components need not be formed in the disclosed shapes, or assembled in the disclosed configuration, but could be provided in virtually and shape, and assembled in virtually and configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

I claim:

1. A receptacle for the collection of mammal semen comprising of:
a ridged cylinder
a filter material fused to the bottom and/or sides of the cylinder, creating a receptacle for mammal semen, such that the semen component may pass through the filter into a vessel that has been placed beneath the cylinder-filter device, the disposable cylinder with the attached filter and unfiltered ejaculate component being separable from the vessel and the contained semen component.

2. An apparatus for the collection and filtration of mammal semen, comprising of:
a ridged cylinder
a filter element fixed to portions of the cylinder
